(19) United States
(12) Patent Application Publication
(10) Pub. No.: US 2014/0159783 A1
(43) Pub. Date: Jun. 12, 2014

(54) ELECTRONIC DEVICE AND RESET CIRCUIT

(71) Applicant: HON HAI PRECISION INDUSTRY CO., LTD., New Taipei (TW)

(72) Inventor: TIEN-YU LIN, New Taipei (TW)

(73) Assignee: HON HAI PRECISION INDUSTRY CO., LTD., New Taipei (TW)

(21) Appl. No.: 14/065,493

(22) Filed: Oct. 29, 2013

(30) Foreign Application Priority Data
Dec. 10, 2012 (TW) 101146354

(51) Int. Cl. G06F 1/24

(52) U.S. Cl. CPC G06F 1/24
USPC 327/142

(57) ABSTRACT

A reset circuit is connected to a processor chip to reset the processor chip. The reset circuit includes a control unit, a standby power, and a voltage converting unit. The standby power provides power to the control unit. The control unit receives external control signals and outputs an enable signal in responds to the external control signal. The voltage converting unit converts an external voltage into a work voltage and generates a reset signal in responds to the enable signal. The voltage converting unit provides the work voltage to the processor chip and transmits the enable signal to control the processor chip to reset.

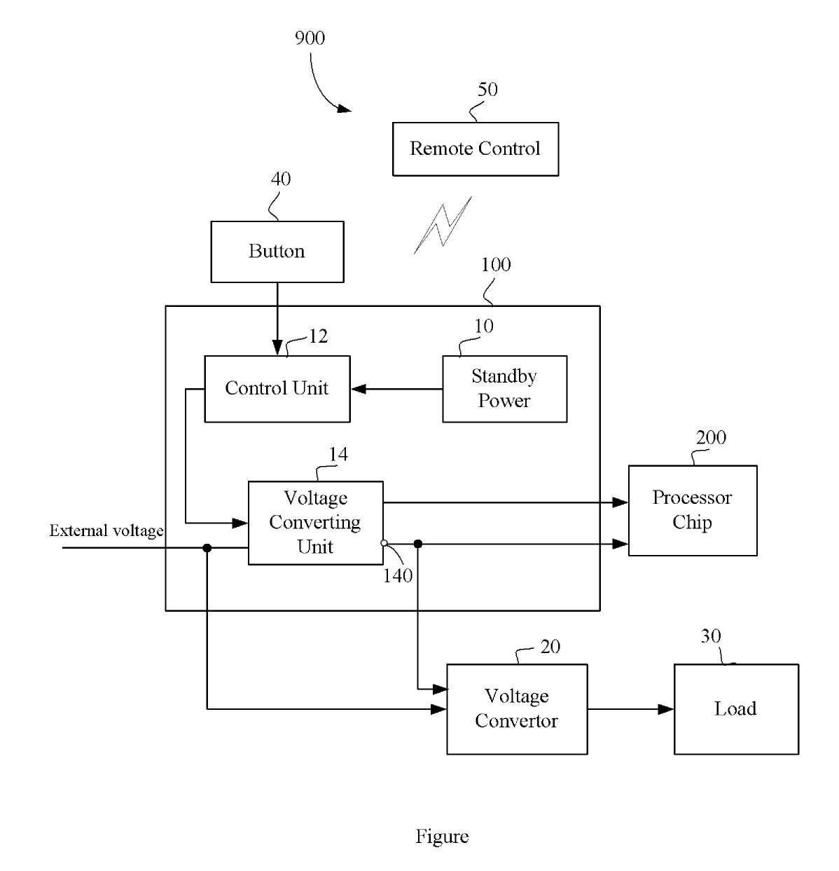

### BACKGROUND

1. Technical Field

The discloser relates to electronic device, and particularly to an electronic device with a reset circuit.

2. Description of Related Art

In order to reset a processor chip, a typical circuit includes a power circuit and a reset chip. The power circuit provides power to the processor chip, the reset chip outputs a reset signal to control the processor chip to reset, such that the processor chip will work normally. However, most reset chips are complex.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

The FIGURE shows functional blocks of an electronic device in accordance with an embodiment.

### DETAILED DESCRIPTION

The FIGURE shows an embodiment of an electronic device 900. The electronic device 900 includes a reset circuit 100, a processor chip 200, a voltage converter 20, a load 30, and buttons 40. The reset circuit 100 is electrically connected to the buttons 40, the processor chip 200, and the voltage convertor 20. The load 30 is electrically connected to the voltage converter 20. The reset circuit 100 includes a standby power 10, a control unit 12, and a voltage converting unit 14.

The standby power 10 provides power to the control unit 12.

The control unit 12 receives an external control signal, and responds to the external control signal to output an enable signal to the voltage converter 14. In this embodiment, the control unit 12 is electrically connected to the button 40 and receives the external control signal generated by the button 40 when the button 40 is pressed. In other embodiments, the control unit 12 receives the external control signal generated by a remote control 50.

The voltage converting unit 14 is electrically connected to the control unit 12. The voltage converting unit 14 responds to the enable signal to covert an external voltage to a work voltage and generate a reset signal based on the work voltage. In this embodiment, the voltage converting unit 14 is a DC/DC voltage converter. The work voltage is provided to the processor chip 200 to enable the processor chip 200, and the reset signal is transmitted to the processor chip 200 to reset the processor chip 200. In this embodiment, the voltage converting unit 14 outputs the reset signal continually to the processor chip 200, the processor chip 200 stops receiving the reset signal when the processor chip 20 has reset. In detail, the voltage converting unit 14 compares the work voltage with a threshold voltage, and outputs the reset signal when the work voltage is equal or higher than the threshold voltage. Otherwise, when the work voltage is lower than the threshold voltage, the voltage converting unit 14 does not output the reset signal, in order to prevent the processor chip 200 from resetting. Thus, the processor chip 200 is provided with low voltage protection. In this embodiment, the voltage converting unit 14 includes a reset pin 140 electrically connected to the processor chip 200. The reset signal is a high voltage signal. When the work voltage is equal or higher than the threshold, the reset pin 140 outputs the high voltage signal which is the reset signal. Otherwise, when the work voltage is lower than the threshold voltage, the reset pin 140 outputs a low voltage signal, which is not the reset signal.

The reset signal is further transmitted to the voltage convertor 20 to enable the voltage convertor 20 to convert an external voltage into a supply voltage which enables the load 30. In this embodiment, the processor chip 200 is a television signal processor chip, the load 30 is a display or a speaker.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A reset circuit, electrically connected to a processor chip, the reset circuit comprising:
a control unit receiving an external control signal and outputting an enable signal in responds to the external control signal;
a standby power providing power to the control unit; and
a voltage converting unit converting an external voltage into a work voltage and generating a reset signal in responds to the enable signal; the voltage converting unit transmitting the work voltage to enable the processor chip and transmitting the reset signal to control the processor chip to reset.

2. The reset circuit of claim 1, wherein the voltage converting unit further compares the work voltage with a threshold voltage, when the work voltage is lower than the threshold voltage, the voltage converting unit does not outputs the reset signal to the processor chip; when the work voltage is not lower than the threshold voltage, the voltage converting unit outputs the reset signal to the processor chip.

3. The reset circuit of claim 2, wherein the reset signal is high voltage signal.

4. The reset circuit of claim 3, wherein when the work voltage is lower than the threshold voltage, the voltage converting unit outputs a low voltage signal.

5. The reset circuit of claim 1, wherein the reset signal is further transmitted to a voltage convertor to enable the voltage convertor to convert the external voltage into a supply voltage to enable a load.

6. The reset circuit of claim 1, wherein the control unit receives the external control signal generated by a remote device.

7. The reset circuit of claim 1, wherein the control unit receives the external control signal generated by pressing a button electrically connected to the control unit.

8. An electronic device, comprising:
a reset circuit, comprising:
a control unit receiving an external control signal and outputting an enable signal in responds to the external control signal;
a standby power providing power to the control unit; and
a voltage converting unit converting an external voltage into a work voltage and generating a reset signal in responds to the enable signal; and
a processor chip being enabled by the work voltage and resets in responds to the reset signal.

9. The electronic device of claim 8, wherein the voltage converting unit further compares the work voltage with a threshold voltage, when the work voltage is lower than the threshold voltage, the voltage converting unit does not outputs the reset signal to the processor chip; when the work voltage is not lower than the threshold voltage, the voltage converting unit outputs the reset signal to the processor chip.

10. The electronic device of claim 9, wherein the reset signal is a high voltage signal.

11. The electronic device of claim 10, wherein when the work voltage is lower than the threshold voltage, the voltage converting unit outputs a low voltage signal.

12. The electronic device of claim 8, wherein the reset signal is further outputted to a voltage convertor to enable the voltage convertor to convert the external voltage into a supply voltage to enable a loader.

13. The electronic device of claim 8, wherein the control unit receives the external control signal generated by a remote device.

14. The electronic device of claim 8, wherein the control unit receives the external control signal generated by pressing a button electrically connected to the control unit.
